(19) United States
(12) Patent Application Publication
(10) Pub. No.: US 2010/0163414 A1
(43) Pub. Date: Jul. 1, 2010

(54) MICROELECTRONIC DEVICE WITH FIELD ELECTRODES

(75) Inventors: Murray Fulton Gillies, Eindhoven (NL); Marc Wilhelmus Gijsbert Ponjee, Eindhoven (NL); Mark Thomas Johnson, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/293,603

(22) PCT Filed: Mar. 12, 2007
(86) PCT No.: PCT/IB07/50815

§ 371 Date: Sep. 19, 2008

(30) Foreign Application Priority Data
Mar. 21, 2006 (EP) 06111439.3
Oct. 9, 2006 (EP) 06121978.8

(51) Int. Cl. G01N 27/26; B01D 57/02

(52) U.S. Cl. 204/547; 204/643; 204/600; 204/450

(57) ABSTRACT

The invention relates to a microelectronic device, particularly a microelectronic biosensor, comprising an array of field electrodes (FE) for generating an alternating electrical field (E) in an adjacent sample chamber (SC). The field electrodes (FE) are coupled to associated local oscillators (OS), which are preferably tunable and connected in a matrix pattern to an external control unit (CU). The local oscillators (OS) allow high frequencies of the generated electrical fields (E), such that for example dielectrophoretic forces can be generated.

The invention relates to a microelectronic device for manipulating a sample, comprising a sample chamber and an array of field electrodes. Moreover, it relates to the use of such a microelectronic device as a biosensor.

Integrated microelectronic devices comprising biosensors and micro-fluidic devices are known under different names, e.g. as DNA/RNA chips, BioChips, GeneChips and Lab-on-a-chip. In particular, high throughput screening on (micro)arrays is one of the new tools for (bio)chemical analysis, for instance employed in diagnostics. These biochip devices comprise small volume wells or reactors, in which chemical or biochemical reactions are examined, and may regulate, transport, mix and store minute quantities of liquids rapidly and reliably to carry out desired physical, chemical, and biochemical reactions and analysis in large numbers. By carrying out assays in small volumes, significant savings can be achieved in time and the costs of targets, compounds and reagents.

The WO 03/045556 A2 describes a microfluidic platform comprising a thin film transistor active matrix liquid crystal display in which the array of electrodes is selectively controlled to move liquids by electro-wetting forces. The effect of electro-wetting requires however an interface between the liquid to be moved and another material, particularly a gas.

Based on this situation it was an object of the present invention to provide means that allow a versatile manipulation of samples in a microfluidic device. In particular, it is desirable that flow can be induced within a liquid and that particles in a sample can directly be affected.

These objectives are achieved by a microelectronic device according to claim 1 and a use according to claim 22. Preferred embodiments are disclosed in the dependent claims.

The microelectronic device according to the present invention is intended for the manipulation of a sample, particularly a liquid or gaseous chemical substance like a biological body fluid which may contain particles. The term “manipulation” shall denote any interaction with said sample, for example measuring characteristic quantities of the sample, investigating its properties, processing it mechanically or chemically or the like. The microelectronic device comprises the following components:
a) A sample chamber in which the sample to be manipulated can be provided. The sample chamber is typically an empty cavity or a cavity filled with some substance like a gel that may absorb a sample substance; it may be an open cavity, a closed cavity, or a cavity connected to other cavities by fluid connection channels.
b) An array of field electrodes with associated local oscillators for generating an alternating electrical field in at least a sub-region of the sample chamber. The “association” between the electrodes and the oscillators shall denote that each electrode is linked to at least one oscillator and vice versa. Typically, each field electrode will be linked to just one associated oscillator, while each oscillator may be linked to just one electrode or to a group of several electrodes. Moreover, the term “local” shall indicate that each oscillator is favorably located in the vicinity of its associated electrode(s). The oscillators are therefore typically distributed in a similar array form as the electrodes.

The described microelectronic device has the advantage that the coupling of field electrodes to associated local oscillators eases the generation of alternating fields. A spatially close arrangement of electrodes and oscillators particularly allows the generation of high-frequency fields, as cross-talk and similar negative effects accompanying the propagation of high-frequency signals over long distances are avoided.

According to a further development of the invention, the microelectronic device comprises a control unit (either integrated into the same substrate as the field electrodes or external thereto) that is connected to the local oscillators and/or to the field electrodes for individually controlling the oscillators/electrodes or for individually controlling groups of several oscillators/electrodes (wherein a group of commonly controlled electrodes may for example establish a quadrupole). The individual control of oscillators/electrodes provides a maximal flexibility and allows the realization of many different applications like pumping, particle concentration, particle separation and the like.

As was already mentioned, each local oscillator may be associated to just one field electrode. In a preferred embodiment, there is however at least one local oscillator that is shared between two or more of the field electrodes. Preferably, all local oscillators are shared by several field electrodes in this embodiment. Such a sharing of local oscillators allows to simplify the design and is particularly possible if the associated electrodes cooperate (e.g. in a quadrupole).

The field electrodes may particularly be used to exert forces on objects and/or a fluid in the sample chamber via (AC or DC) electro-osmosis, electrophoresis, dielectrophoresis, electrohydrodynamics and/or a combination of these effects. In the case of dielectrophoresis real bio-particles in the sample maybe too small for manipulation and therefore larger diameter particles with the desired electrical properties may be added to the liquid to facilitate mixing.

The microelectronic device may optionally be adapted to drive the field electrodes with individually and/or temporarily different frequencies. This possibility is particularly achieved by an appropriate design of the local oscillators and/or of an associated control unit. If the electrodes can be driven with individually different frequencies, a spatial pattern of frequency-dependent effects like dielectrophoretic forces can be generated. If the field electrodes can be driven with temporarily different frequencies, frequency-dependent effects can be changed over time as desired. If both the operation with individually and temporarily different frequencies is possible, a maximal flexibility is achieved with a simultaneous spatial and temporal control of frequency-dependent effects.

In another embodiment of the invention, the microelectronic device is adapted to generate a moving pattern—particularly a traveling wave—of electrical activity in the array of field electrodes. The term “electrical activity” is to be understood in this context in the most general sense, for example describing an electrical potential of certain amplitude and/or frequency. The moving pattern may for example comprise the distribution of different frequencies of the electrical field generated by the field electrodes, or an electrical field concentrated at certain locations and surrounded by a region of zero electrical field. If the electrical fields are used for exerting forces on particles or a fluid, the moving pattern can be used to induce a directed flow of said particles or fluid.

In another particular embodiment, the field electrodes are arranged in a two-dimensional pattern on at least one side of a microfluidic channel, which constitutes the sample chamber or at least a part thereof In this embodiment, a sample can be manipulated in the microfluidic channel, and particularly be driven forward to establish and maintain a flow.

According to another particular embodiment of the invention, the microelectronic device comprises a row of field electrodes disposed next to each other that are operated with frequencies which continuously increase along said row. Frequency dependent effects like dielectrophoretic forces will then accordingly change along the row of electrodes, which allows for example a spatial separation of particles with different electrical properties.

The interface between the sample chamber and the array of field electrodes may be chemically coated in a pattern, for instance a pattern that corresponds to the pattern of the field electrodes. Thus the effect of the electrodes can be combined with chemical effects. The chemical coating may particularly comprise binding sites or hybridization spots that specifically bind to target molecules in a sample. For the case of cells a cell adhesion layer may be used. The binding sites, hybridization spots and/or cell adhesion layer may particularly be located close to or above the field electrodes such that they are in the focus of their effects and a sample substance can be trapped by electrical fields of the field electrodes. Moreover, an arrangement above the electrodes has the advantage to leave free space between the electrodes through which for example light from a background light source can pass. Thus the field electrodes can assist the process of binding a sample to the interface for further analysis. There afterwards the polarity of the force can be reversed to remove non-bonded material. In another embodiment, the forces exerted using the field electrodes are changed to mix non-bonded material. Subsequently, the field electrodes may be again used for trapping.

Moreover, at least some of the field electrodes may optionally be arranged as a multipole, preferably a quadrupole, hexapole or octopole. Such a design may be advantageous for concentrating particles at certain focus-location(s) of a sample.

In another embodiment of the microelectronic device, at least one of the local oscillators is a tunable oscillator, preferably a relaxation oscillator or a ring oscillator. The output frequency of a tunable oscillator can be adjusted as desired by external commands, allowing a wide variety of interesting applications.

In the aforementioned embodiment, the frequency of the tunable local oscillator(s) is preferably controlled by an external control signal, for example a control current or a control voltage. Said control signals can be DC or low-frequency signals, as they only have to convey the value of the desired oscillator frequency, not a signal of said frequency itself. This is particularly favorable if high output frequencies are desired, as they can be generated by the local oscillators as close as possible to the field electrodes and do not have to travel over longer distances.

If a control current is used in the aforementioned embodiment, this current is preferably mirrored by an addressing unit to the associated frequency oscillator.

In another embodiment of the invention, the microelectronic device comprises local output buffers that are coupled to the local oscillators for generating an output signal, for example a voltage or a current, with an amplitude that is independent of the frequency of the signal. Thus a frequency dependence of the output signal can be avoided that is often present in specific hardware realizations of an oscillator.

The microelectronic device may further comprise local converters for converting an output or input voltage of the local oscillators into a current, or an output or input current of the local oscillators into a voltage. The local converters therefore allow to transform the available output/input signal of the oscillators into a signal form that is required by the field electrodes.

In another embodiment of the microelectronic device, each field electrode is locally associated to an addressing unit, a driving unit and/or a memory unit. The memory unit may for example be realized by a capacitor that stores the voltage of control signals. The memory allows to continue a commanded operation of a field electrode while the associated control line is disconnected again and used to control other electrodes.

The microelectronic device may optionally comprise at least one sensor element, preferably an optical, magnetic or electrical sensor element for sensing properties of a sample in the sample chamber. A microelectronic device with magnetic sensor elements is for example described in the WO 2005/010543 A1 and WO 2005/010542 A2. Said device is used as a microfluidic biosensor for the detection of biological molecules labeled with magnetic beads. It is provided with an array of sensor units comprising wires for the generation of a magnetic field and Giant Magneto Resistance devices (GMRs) for the detection of stray fields generated by magnetized beads.

In a further development of the invention, the microelectronic device comprises at least one heating electrode for exchanging heat with at least a sub-region of the sample chamber when being driven with electrical energy, wherein said heating electrode is preferably also a field electrode. As the name “heating electrode” indicates, this electrode preferably converts electrical energy into heat that is transported into the sample chamber. It is however also possible that the heating electrode (e.g. a Peltier element) absorbs heat from the sample chamber and transfers it to somewhere else under consumption of electrical energy. The presence of heating electrodes has the advantage that the temperature in the sample chamber can be controlled, which is of crucial importance for many biological samples and assays.

In a further development of the invention, the microelectronic device comprises at least one temperature sensing element to obtain a measure for the temperature of at least a sub-region of the sample chamber, wherein said temperature sensing element is preferably also a field electrode. The presence of the temperature sensing element(s) has the advantage that the temperature in the sample chamber can be controlled using feedback, by use of signals coming from temperature sensing element(s) that are related to the temperature of said sample chamber for driving e.g. external heaters or heating electrodes of the aforementioned kind.

According to another embodiment, the microelectronic device may comprise at least one conductivity sensing element to measure the conductivity of a material, e.g. a sample fluid, in the sample chamber. The measured conductivity can then for instance be coupled back as feedback for the drive electronics of the field electrodes. This is particularly favorable in dielectrophoresis applications, as the conductivity of a medium (which can vary from sample to sample) is important for the cross-over frequency in this case.

The microelectronic device may optionally further comprise at least one light source for illuminating at least a sub-region of the sample chamber. Such an illumination can for example be necessary for investigations based on fluorescent detection or detection of light scattering properties of the sample.

The field electrodes may preferably be realized in thin film electronics. Moreover, a large area electronics (LAE) matrix approach, preferably an active matrix approach may be used in order to contact the electrodes. The technique of LAE, and specifically active matrix technology using for example thin film transistors (TFTs) is applied for example in the production of flat panel displays such as LCDs, OLED and electrophoretic displays.

The invention further relates to the use of the microelectronic devices described above for molecular diagnostics, biological sample analysis, or chemical sample analysis, food analysis, and/or forensic analysis. In particular, the microelectronic devices described above may be used in clinical applications based on molecular diagnostics. Molecular diagnostics may for example be accomplished with the help of magnetic beads or fluorescent particles that are directly or indirectly attached to target molecules.

These and other aspects of the invention will be apparent from and elucidated with reference to the embodiment(s) described hereinafter. These embodiments will be described by way of example with the help of the accompanying drawings in which:

FIG. 1 shows schematically a microelectronic device according to the present invention comprising field electrodes and local oscillators;

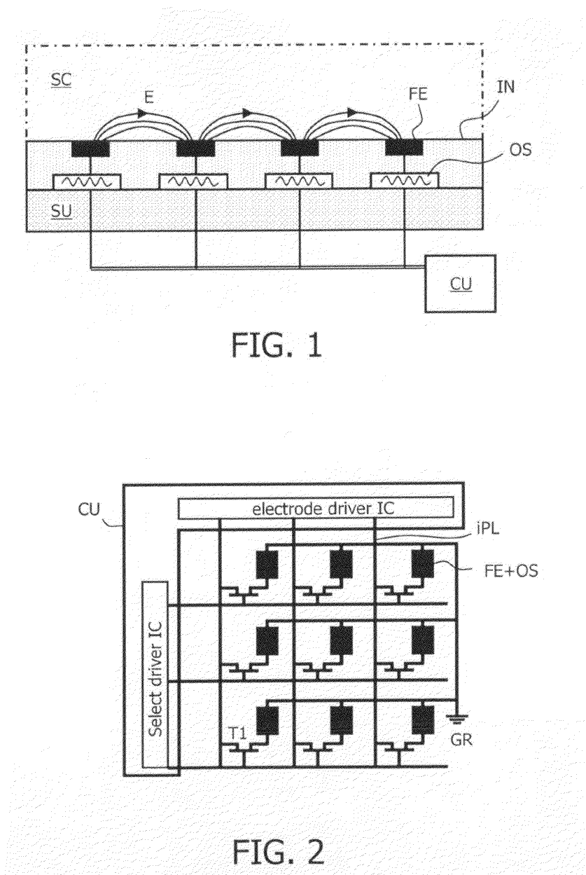

FIG. 2 shows schematically the connection of an array of local oscillators and field electrodes in a matrix pattern;

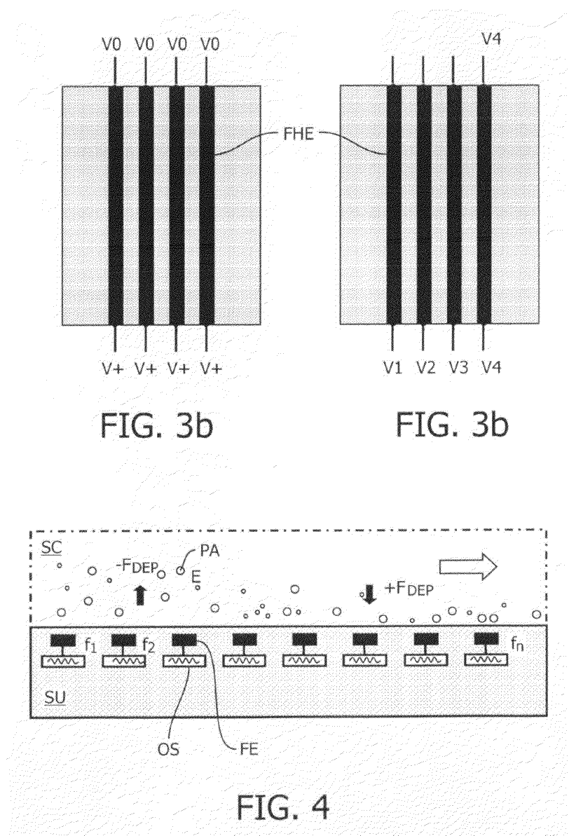

FIG. 3 shows schematically a top view of a row of field electrodes that may optionally be used as heating electrodes;

FIG. 4 shows schematically a section through a microelectronic device according to the present invention that is used for the separation of particles with different sedimentation characteristics;

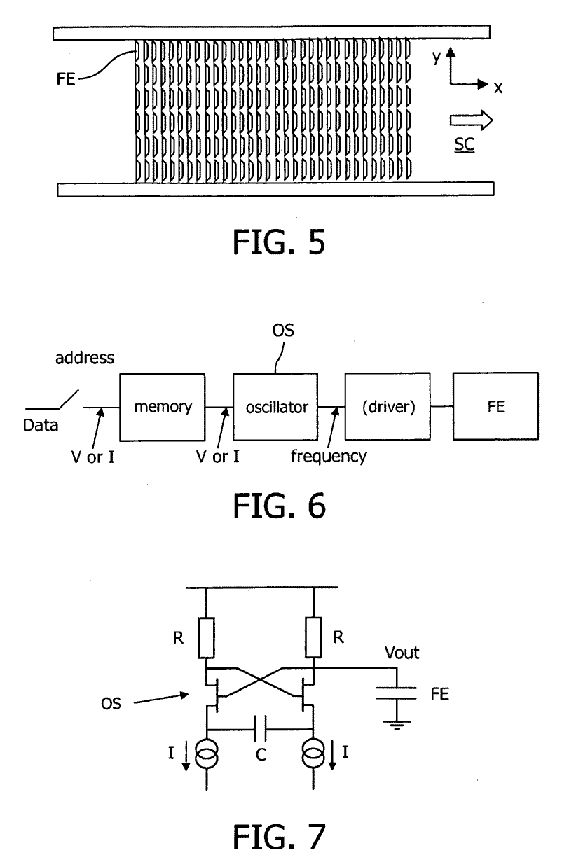

FIG. 5 shows schematically a top view of a microfluidic channel that is covered with a two-dimensional array of field electrodes;

FIGS. 6 to 15 show different designs concerning the addressing and control of local oscillators.

Like reference numbers in the Figures refer to identical or similar components.

Biochips for (bio)chemical analysis, such as molecular diagnostics, will become an important tool for a variety of medical, clinical, forensic and food applications. In general, biochips comprise a biosensor in most of which target molecules (e.g. proteins, DNA) are immobilized on biochemical surfaces with capturing molecules and subsequently detected using for instance optical, magnetic or electrical detection schemes. Examples of magnetic biochips are described in the WO 2003/054566, WO 2003/054523, WO 2005/010542 A2, WO 2005/010543 A1, and WO 2005/038911 A1, which are incorporated into the present application by reference.

FIG. 1 shows in this respect a schematic cross section through a microelectronic device according to the present invention. The device comprises a sample chamber SC in which a sample to be investigated can be provided. Moreover, it comprises a chip comprising a substrate SU (e.g. a glass plate) which constitutes the bottom wall of the sample chamber. The interface IN between said chip and the sample chamber SC is preferably coated with binding sites (not shown) to which target molecules of a sample (optionally labeled with detectable markers) can specifically bind.

A one- or two-dimensional array of field electrodes FE is disposed on the substrate SU, wherein each of said the electrodes is coupled to an associated local oscillator OS. The oscillators OS are further coupled to an (external) control unit CU such that they can be individually addressed. Optional further components of the microelectronic device like sensor elements for the detection of bound target molecules are not shown in FIG. 1 for simplicity. The device may also contain electrodes which are either ground to provide a reference voltage or used to apply a DC voltage. The local oscillators OS drive the field electrodes FE with an electrical signal of a selected frequency such that alternating electrical fields E are correspondingly generated in the sample chamber SC. It is also possible that he oscillating signal contains a DC component. The frequency and spatial distribution of these fields E can be controlled by the external control unit CU.

When a large number of electrodes is used, conventional large area electronics should be used to allow individual addressing of the electrodes without an excessively large number of connections to the outside world.

In the embodiment shown in FIG. 2, an active matrix is used as a distribution network to route the electrical signals required for local oscillators OS (or the field electrodes) from a central driver CU via individual power lines iPL to the local oscillators OS. In this example, the local oscillators OS are provided as a regular array of identical units, whereby these units are connected to the driver CU via the transistors T1 of the active matrix. The gates of the transistors are connected to a select driver (for example a standard shift register gate driver as used for an Active Matrix Liquid Crystal Display AMLCD), whilst the source is connected to the electrode driver, for example a set of voltage or current drivers. The operation of this array is as follows:
To activate a given local oscillator OS, the transistors T1 in the entire row of compartments incorporating the required oscillator are switched into the conducting state (by e.g. applying a positive voltage to the gates from the select driver).
The signal (voltage or current) on the individual power line iPL in the column where the local oscillator OS is situated is set to its desired value. This signal is passed through the conducting TFT to the oscillator.
The driving signal in all other columns is held at a voltage or current, which will not cause oscillator activity (this will typically be 0V or 0 A).

As such, the matrix preferably operates using a “line-at-a-time” addressing principle, in contrast to the usual random access approach taken by CMOS based devices.

It is also possible to activate more than one oscillator in a given row simultaneously by applying a signal to more than one column in the array. It is possible to sequentially activate electrodes in different rows by activating another line (using the gate driver) and applying a signal to one or more columns in the array.

Whilst in the embodiment of FIG. 2 a driver is considered that is capable of providing (if required) individual signals to all columns of the array simultaneously, it would also be feasible to consider a more simple driver with a function of a de-multiplexer.

In another embodiment of the invention it is proposed to use a single patterned layer of electrodes FHE for both temperature control and electrical manipulation of fluids/biomolecules by sequential application of a voltage across a (resistive) electrode FHE (i.e. for heating and temperature sensing, FIG. 3a) and between the electrodes FHE (i.e. for electrical manipulation of fluids/biomolecules, FIG. 3b). The patterned electrode layer may be covered with a (partially) electrically insulating layer (e.g. SU-8, polyimide, polycarbonate, polypropylene, SiO₂, native metallic oxide) and/or with a biocompatible layer (e.g. SU-8, polycarbonate, polypropylene). Each electrode FHE has at least two contacts. At least two contacts are used in case the (resistive) electrode is used for heating or temperature sensing (FIG. 3a). In case the electrode is used for electrical manipulation of fluids/biomolecules (FIG. 3b), (distinct) voltages V1, V2, V3, V4 are applied via at least one contact. Applying these voltages via more than one contact (shown for the rightmost electrode in FIG. 3b) may be advantageous in order to reduce the time it takes to put the complete electrode at the desired potential and reduce the possibility of potential drop along lines.

The alternating electrical field that can be generated by the field electrodes of the described microelectronic devices can be used for different purposes. In the following examples, the electrodes are used to exert forces on particles or a fluid in the sample chamber. In this case, it is the aim to provide electrode structures suitable for the manipulation of biological material in a bio-sensor or bio-chemical reaction chamber, in particular to allow lateral transport of bio-material and the accumulation of material (e.g. at a location suitable for rear illumination of the sample, i.e. illumination through the substrate containing the electrode structures).

There are various forces that can arise when electric fields are applied to a liquid containing biological material. These forces include the (di)electrophoretic force, the electro-osmotic force, electrothermal forces, the Coulomb force and the dielectric forces. The first of these forces, the (di)electrophoretic force, is a force which acts directly on the bio-particles rather than on the liquid or ions in the liquid and is therefore suitable for selective particle manipulation.

To analyze the manipulation of bio-material using the dielectrophoretic (DEP) force, a spherical homogeneous dielectric particle suspended in an aqueous medium can be taken as a model. The dielectrophoretic force F_{DEP} acting on this particle is given by:

F_{DEP}=2πεₘa³Re[K(ω)]∇|Eᵣₘₛ|²

where εₘ is the permittivity of the medium, a the particle radius, and K(ω) the Clausius-Mossotti factor given by

$$K ( w ) = \frac{{\overline{ɛ}}_{p} - {\overline{ɛ}}_{m}}{{\overline{ɛ}}_{p} + 2 {\overline{ɛ}}_{m}}$$

where ε̅ₚ and ε̅ₘ are the complex permittivities of the particle and the medium, respectively. For an isotropic homogeneous dielectric, the complex permittivity is:

$$\overline{ɛ} = ɛ - j \frac{σ}{ω}$$

where σ is the conductivity of the dielectric and ω the frequency of the applied field. The DEP force can be either positive or negative depending on the frequency of the applied E-field and the resulting sign of Re[K(ω)]. For positive DEP, particles are attracted to high field strength regions on the substrate while negative DEP results in particles collecting in the low field regions. The transition frequency between negative and positive DEP is known as the cross-over frequency and can vary between a few hundred kHz and several MHz depending on the conductivity, the dielectric constants of the medium and particle, and the size of the particle. To allow the manipulation of small particles e.g. proteins of 20 nm, a high frequency E-field is required, and it is therefore advantageous if the electrodes used to apply the voltages are of low resistance i.e. metallic rather than other materials such as transparent conductive oxides (e.g. ITO).

In the following, various applications of alternating electrical fields and of DEP forces and their specific problems are considered. To solve all the particular problems of these applications, it is suggested to create electrode structures on a glass substrate that is foreseen with standard large area electronics (LAE), such that each electrode can be individually addressed. With standard large area electronics either LTPS or amorphous Si is deposited on a glass substrate. A planarization material, such as BCB (bisbenzocyclobutane), may be present between the large area electronics and the field electrodes. It is standard that vias are used and this brings no extra cost. Moreover, deposited hybridization spots are preferably aligned with the electrode structures. Even more preferably the hybridization spots are positioned next to the electrodes, such that metallic electrodes can be used without hampering optical illumination/detection.

### First Application: Quadrupoles

A first application relies on the use of a quadrupole, for example in order to confine particles. At a low frequency of the electrical field, positive DEP can be generated and the particles are attracted to the high field regions near the electrodes of the quadrupole. At sufficiently high frequencies, negative DEP can be observed and the particles are contained at the centre of the quadrupole. Such a behavior can for instance be exploited if fluorescent markers are used to detect target biological material. These markers can be the optical beacons that are used during DNA amplification, labeled proteins and immobilized or hybridized (labeled) nucleic acids on a surface. In case of array-based biosensors with single binding event sensitivity, large biomolecules have low concentrations in the order of pMol, and the binding kinetics will become diffusion limited. Electrical manipulation, for instance using a quadrupole structure, offers the ability to influence the binding-kinetics of molecules to a surface, and allows to increase the speed of measurement, which will become essential for future generations where reduced concentrations of bio-markers are to be measured.

The cross-over frequency in a quadrupole is particle dependent. In the case of multiple chamber detection (such as in a bio chip) where different molecules are to be detected in different chambers, the trapping and subsequent manipulation of the particles therefore requires each quadrupole to be individually addressable. A consequence of this is that the number of electrical connections required for the quadrupoles is equal to four (or two if opposite poles are connected) times the number of chambers. What is more, each chamber requires a frequency oscillator. For an array of quadrupoles the creation of vias or cross-overs is also necessary. All these requirements can favorably be met with the proposed use of LAE.

If vias are used, a dense array of quadrupoles can be created without the wiring interfering with neighboring quadrupoles. Each quadrupole can be driven at the frequency required to trap a specific molecule. With a matrix the number of connections is not 4×(the number of chambers) but 4×(the number of rows plus the number of columns). Since the number of connections is no longer critical it is possible to increase the number of poles and create hexapoles or octopoles. The advantage of more poles is that ∇|Eᵣₘₛ|² becomes larger at the same radius from the centre of the electrode construction and so the DEP force is also stronger.

The focusing of the biological material on a hybridization spot placed in the centre of a quadrupole increases locally the concentration of the material that has to be detected. Moreover, by switching the quadrupole between negative and positive DEP, via switching the frequency, any non-bonded material could be flushed away thus further reducing the background.

Further, deposition of hybridization spots in between the electrodes of a quadrupole (or another electrode structure) on a glass substrate is advantageous as the sample is collected in an area where no electrodes are present. Metal electrodes can therefore be used. Not only does this give maximum freedom in depositing the hybridization spot, but the options of back illumination and evanescent field detection are also possible since the electrodes do not obstruct. Alternatively, illumination from the front side could be used without excessive reflection from the electrodes.

### Second Application: Electrical Smear (Particle Sortation)

The DEP force can also be used to sort biological material. An example of this is the electrical smearing of cells as shown in FIG. 4 (cf. also D. Homes et al., IEEE Engineering in medicine and biology magazine, 85-90 (2003)). A stream of cells PA is generated in a sample chamber SC above DEP generating field electrodes FE. The DEP electrodes FE are divided into regions where electrical signals of different frequency can be applied. On the left hand side, immediately after the particles enter the chamber SC, a signal of a frequency f₁ with a few kHz is applied. The frequency f₂, f₃, . . . fₙ of the applied signal increases as one moves to the right hand side of the chamber. Depending on the surface properties of the cells PA (surface charge, both real and imaginary parts of the permittivity, etc.), the frequency at which the negative DEP force −F_{DEP} cancels the sedimentary force will dictate where the cells will touch the bottom surface. This surface is coated with cell capturing material. It is feasible to use this technique to not only separate cells but also any other biological particles that experience different DEP force due to size, surface charge, permittivity or dielectric inhomogeneity.

The resolution of the electrical smear is governed by the number of different frequencies that can be applied to the sample to create various magnitudes of the DEP force. For a high resolution smear then the required connections become excessive. A matrix construction allows however an increase in the number of connection leads well beyond that possible if direct wiring is used.

### Third Application: Lateral Control of Particles

The lateral movement of biological material is for example required for transporting them along a microfluidic channel. Using the DEP force generated by electrodes at both (small) sides of a channel is however insufficient in wide channels of typically 300 μm breadth, as said force is strongest only in the vicinity of the electrodes, i.e. in a range of about 0.1 to 10 μm.

According to FIG. 5, the solution that is offered by the present invention comprises an array of field electrodes FE distributed over the full width in the top or bottom side of a micro fluidic channel SC. This can be achieved by creating potential islands and therefore requires via structures. Again as it is necessary to be able to address each island with a voltage it is important to use a matrix such that the number of connections to the outside world is not excessive. The use of the electrode structure of FIG. 5 also offers the opportunity to not only apply traveling waves of electrical signal in the x direction but to also manipulate particles in the y direction via for example applying a traveling wave which creates negative DEP force along this axis.

While it would be possible to simply incorporate a switch at the electrode structure of the described applications, it is proposed here to incorporate a frequency oscillator OS on the glass at each electrode. This is especially favorable for quadrupoles as high frequencies (>1 MHz) are often necessary for small particle confinement and with local frequency oscillators the line capacitance is no longer relevant (thus allowing higher frequencies and significantly reducing power dissipation). In addition, it makes it possible to use higher resistance transparent electrodes (as again the RC delay and power is low).

In general, each field electrode or subset of grouped electrodes will be associated as shown in FIG. 6 with an active matrix circuit which compose an addressing element, an oscillating element (typically a tunable oscillator), a memory function, optionally a driving function, and one or more electrodes. Of these functions, the addressing element may be a simple switch and the memory function usually a storage capacitor.

There are many methods of producing a tunable oscillator. One class of oscillators, known as relaxation oscillators, is frequency tunable by altering the current supplied to the integrated electronics; an example of this class of oscillators OS is shown in FIG. 7. Here, the rate at which the data current fills the switching capacitor C determines the oscillation frequency. An advantage of this oscillator embodiment is that all TFTs have the same polarity, which makes the circuit also implementable in a-Si technology.

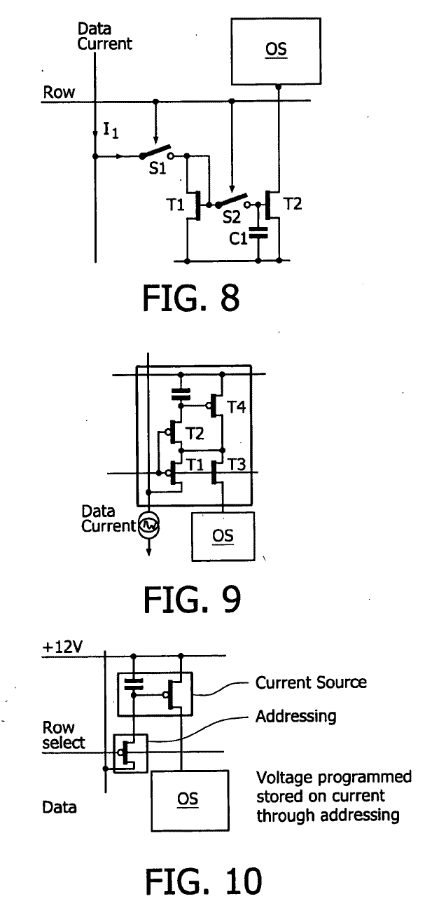

In this class of oscillators, the current required to set the oscillator frequency could be directly supplied by the data driving circuits and mirrored onto the oscillator OS (associated with the optional driver and the field electrode) using the circuits shown in FIGS. 8 and 9. The operation of the circuit in FIG. 8 is as follows:
SAMPLE: close S1 and S2; a current I₁ flows in T1 and a current I₂ (=k·I₁) flows in T2 and the oscillator OS.
HOLD: open S1 and S2; the current I₂ continues to flow in T2 and the oscillator OS.
The operation of the circuit in FIG. 9 is as follows:
1. Close T1 and T2, current I₁ flows in T4.
2. Open T1 and T2.
3. Close T3, current I₁ now flows in T4 and oscillator OS.

FIG. 8 shows a traditional current mirror circuit, whilst in FIG. 9, the current mirror uses the same transistor T4 for sampling the data driver current and driving the oscillator. This single TFT current mirror circuit has the advantage that it is self compensating, and corrects for any variations in the TFT characteristics (such as mobility and threshold voltage). This is important if p-Si TFTs are being used, as here considerable mobility (5-10%) and threshold voltage (+/−1V) variations are found. Any non-uniformity in drive current will be reflected in an equivalent shift in the oscillator frequency.

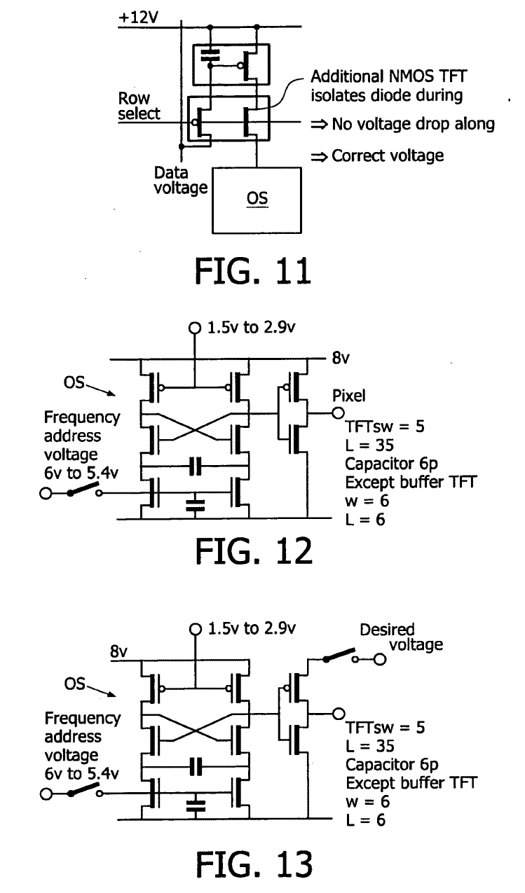

Alternatively, the data could be addressed in the form of a voltage, and the voltage converted to the required current at the level of the oscillator, using the current source circuits shown in FIGS. 10 and 11. In these circuits, the data voltage is applied to the gate of the current source TFT, and its transconductance characteristic is used to define the current (the current increases as the source-gate voltage gets larger). FIG. 11 shows an improved version of the basic circuit, which is much less sensitive to horizontal cross talk (a decrease in output current when moving across the substrate due to voltage drops along the power line).

If both n-type and p-type transistors are available (for example p-Si technology, or CMOS technology), it is possible to produce oscillators with less TFTs. This is advantageous for the open space on the substrate, which can be used for rear illumination and detection. Examples of such oscillators can be found in electronics reference books.

Relaxation oscillators of the type shown in FIG. 7 usually have the characteristic that the amplitude of the output signal changes with the output frequency (in the example of FIG. 7, the voltage is inverse proportional to the current). For many applications it will be necessary to either ensure a constant amplitude output voltage or, more generally, to ensure that the output voltage is variable, independent of the frequency. Both of these situations can be achieved by using output buffers. An example of an implementation of the relaxation oscillator of FIG. 7 with a constant output voltage buffer is given in FIG. 12. In this Figure, the actual implementation of the circuit in p-Si is given (i.e. current sources and resistances are defined by TFTs). The circuit components are furthermore dimensioned to provide oscillation in the 300 Hz-10 kHz bandwidth though the choice of other components would allow other bandwidths. An example of a circuit where the frequency and amplitude of the output voltage are independently variable is shown in FIG. 13. This circuit will require two data signals, one for the frequency (current) and one for the voltage (voltage).

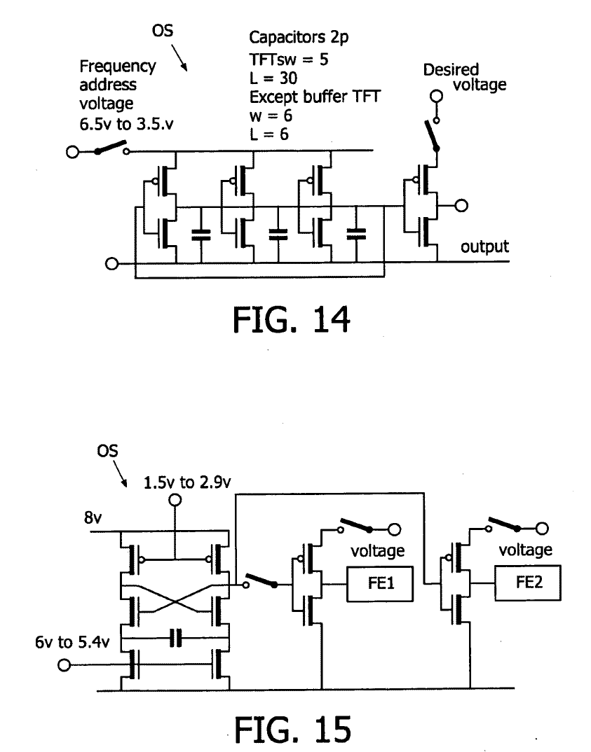

A further class of oscillator circuit which can be implemented in a local tunable oscillator circuit is a ring oscillator. An example of this class of oscillator is shown in FIG. 14. In this example, the frequency and amplitude of the output voltage are independently variable. Again, the circuit components are dimensioned to provide oscillation in the 300 Hz-10 kHz bandwidth. By choosing other components this bandwidth can be altered.

In most cases, the output of the oscillator (a voltage) will directly be used to drive the electrode. In some cases, the electrode will require an oscillating output current. This can again be achieved by converting the oscillating output voltage to a current by using (for example) the transconductance characteristics of a current source TFT, as already shown in FIGS. 10 and 11.

In general, each addressable electrode will be associated with one local oscillator, and the driving circuit will be able to provide input signals to define the oscillation frequency (in general at least one frequency in the positive DEP and one in the negative DEP range) and also of variable amplitude (to influence the DEP force and hence the speed of particle motion). However, in some cases, it may be possible to share a single local oscillator between at least two or more electrodes. For example, in the case of a quadrupole, in general opposite electrodes are driven with the same signal, so could be associated with the same oscillator. Furthermore, if electrodes are to be driven with the same frequency but opposite polarity, the same oscillator OS could be used with electrodes FE1, FE2 either being connected to two separate output buffers of different magnitude, as shown in FIG. 15, or alternatively differently connected with respect to a ground connection to achieve the opposite polarity. In both cases, the circuit complexity reduces with respect to the above embodiments.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic device for manipulating a sample, comprising:
a) a sample chamber (SC);
b) an array of field electrodes (FE, FHE) with associated local oscillators (OS) for generating an alternating electrical field (E) in at least a said sub-region of the sample chamber (SC).

2. The microelectronic device according to claim 1,
characterized in that it comprises a control unit (CU) that is connected to the local oscillators (OS) and/or to the field electrodes (FE, FHE) for individually controlling groups of them.

3. The microelectronic device according to claim 1,
characterized in that at least one local oscillator (OS) is shared between two or more field electrodes (FE, FHE).

4. The microelectronic device according to claim 1,
characterized in that the field electrodes (FE, FHE) exert forces on objects and/or a fluid in the sample chamber (SC) by electro-osmosis, electrophoresis, dielectrophoresis, electrohydrodynamics and/or a combination of these effects.

5. The microelectronic device according to claim 1,
characterized in that it is adapted to drive the field electrodes (FE, FHE) with individually and/or temporarily different frequencies.

6. The microelectronic device according to claim 1,
characterized in that it is adapted to generate a moving pattern, particularly a traveling wave, of electrical activity in the array of field electrodes (FE, FHE).

7. The microelectronic device according to claim 1,
characterized in that the field electrodes (FE, FHE) are arranged in a two-dimensional pattern on at least one side of a microfluidic channel (SC).

8. The microelectronic device according to claim 1,
characterized in that a row of sequential field electrodes (FE, FHE) is operated with increasing frequencies (f1, f2, . . . fn).

9. The microelectronic device according to claim 1,
characterized in that the interface (IN) between the sample chamber (SC) at the array of field electrodes is chemically coated, particularly with binding sites, in a pattern that is preferably adjusted to the pattern of field electrodes (FE, FHE).

10. The microelectronic device according to claim 1,
characterized in that field electrodes (FE) are arranged as a multipole, preferably a quadrupole, hexapole or octopole.

11. The microelectronic device according to claim 1,
characterized in that at least one local oscillator (OS) is a tunable oscillator, preferably a relaxation oscillator or a ring oscillator.

12. The microelectronic device according to claim 11,
characterized in that the frequency of tunable local oscillator (OS) is controlled by an external control signal, preferably a control current or a control voltage.

13. The microelectronic device according to claim 12,
characterized in that the control current is mirrored by an addressing unit to the tunable oscillator (OS).

14. The microelectronic device according to claim 1,
characterized in that comprises local output buffers coupled to the local oscillators (OS) for generating an output signal with a frequency-independent amplitude.

15. The microelectronic device according to claim 1,
characterized in that it comprises local converters for converting an output or input voltage of the local oscillators (OS) into a current or vice versa.

16. The microelectronic device according to claim 1,
characterized in that an addressing unit, a driver unit and/or a memory unit is locally associated to each field electrode (FE).

17. The microelectronic device according to claim 1,
characterized in that it comprises at least one sensor element, preferably an optical, magnetic or electrical sensor element, for sensing properties of a sample in the sample chamber.

18. The microelectronic device according to claim 1,
characterized in that it comprises at least one heating electrode (FHE) for exchanging heat with at least a sub-region of the sample chamber (SC) when being driven with electrical energy, wherein said heating electrode (FHE) is preferably also a field electrode.

19. The microelectronic device according to claim 1,
characterized in that it comprises at least one temperature sensing element to measure the temperature of at least a sub-region of the sample chamber (SC), wherein said temperature sensing element is preferably also a field electrode.

20. The microelectronic device according to claim 1,
characterized in that it comprises at least one conductivity sensing element to measure the conductivity of a material in the sample chamber.

21. The microelectronic device according to claim 1,
characterized in that it comprises at least one light source for illuminating at least a sub-region of the sample chamber (SC).

22. The microelectronic device according to claim 1,
characterized in that it is realized in thin film electronics.

23. The microelectronic device according to claim 22,
characterized in that a large area electronics approach, preferably an active matrix approach, is used to contact the field electrodes (FE, FHE).

24. Use of the microelectronic device according to claim 1 for molecular diagnostics, biological sample analysis, or chemical sample analysis.
